(19) United States
(12) Patent Application Publication
(10) Pub. No.: US 2026/0073146 A1
(43) Pub. Date: Mar. 12, 2026

(54) METHODS AND SYSTEMS FOR DETECTING DISINFORMATION GENERATED BY LARGE LANGUAGE MODELS

(71) Applicants: Bohan Jiang, Tempe, AZ (US); Zhen Tan, Mesa, AZ (US); Ayushi Nirmal, Tempe, AZ (US); Huan Liu, Tempe, AZ (US)

(72) Inventors: Bohan Jiang, Tempe, AZ (US); Zhen Tan, Mesa, AZ (US); Ayushi Nirmal, Tempe, AZ (US); Huan Liu, Tempe, AZ (US)

(73) Assignee: Arizona Board of Regents on Behalf of Arizona State University, Tempe, AZ (US)

(21) Appl. No.: 19/326,482

(22) Filed: Sep. 11, 2025

Related U.S. Application Data
(60) Provisional application No. 63/693,606, filed on Sep. 11, 2024.

(51) Int. Cl. G06F 40/30; G06F 40/284; G06F 40/295

(52) U.S. Cl. CPC G06F 40/30; G06F 40/284; G06F 40/295

(57) ABSTRACT

Systems and methods for detecting disinformation generated from large learning models (LLMs) are disclosed including implementation of one or more prompts that guide an artificial intelligence (AI) model detecting such disinformation. More specifically, prompting techniques can be used to generate new training datasets for the AI model, and other prompting techniques can be implemented to train the AI model on the new training datasets.

### CROSS REFERENCE TO RELATED APPLICATIONS

This is a non-provisional application that claims benefit to U.S. Provisional Patent Application Ser. No. 63/693,606 filed on Sep. 11, 2024, which is herein incorporated by reference in its entirety.

### GOVERNMENT SUPPORT

This invention was made with government support under N00014-21-1-4002 awarded by the Office of Naval Research. The government has certain rights in the invention.

### FIELD

The present disclosure generally relates to computing concepts associated with artificial intelligence (AI) such as large learning models (LLMs) and associated operations; and in particular to methods and systems for detecting disinformation generated by LLMs.

### BACKGROUND

The advent of generative Large Language Models (LLMs) such as ChatGPT has catalyzed transformative advancements across multiple domains. However, alongside these advancements, they have also introduced potential threats. One critical concern is the misuse of LLMs by disinformation spreaders, leveraging these models to generate highly persuasive yet misleading content that challenges the disinformation detection system

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is simplified diagram of a system for detecting disinformation generated by LLMs as described herein.

FIG. 1B is an illustration of general data flow for disinformation generation and detection aspects using a language model such as ChatGPT described herein: human-crafted disinformation (left) inputted along with distinct prompts to produce three separate LLM-generated disinformation datasets (center), followed by subsequent evaluation as to the efficacy of the disinformation detection system (right) against LLM-generated disinformation.

FIG. 1C is a process flow of an example method associated with the concepts of LLM-guided disinformation detection described herein.

FIG. 2 is an illustration of templates of three zero-shot prompts.

FIG. 3 is an illustration of an example of an chain-of-thought prompt.

FIG. 4 is an illustration of linguistic differences between disinformation in Dₕᵤₘₐₙ and D_{gpt_std}.

FIG. 5 is a comparison of text embeddings of Dₕᵤₘₐₙ (blue) and D_{gpt_std} (orange) using t-SNE.

FIG. 6 is a prompt template for detecting disinformation.

FIG. 7 is a comparison of misclassification rate (↓) of GPT-3.5 and 4. w/o and w/ represents LLMs respond without and with the analytic process, respectively.

FIG. 8 is an example of a chain-of-thought prompt.

Corresponding reference characters indicate corresponding elements among the view of the drawings. The headings used in the figures do not limit the scope of the claims.

### DETAILED DESCRIPTION

Aspects of the present disclosure relate to examples of an inventive concept for disinformation detection via artificial intelligence; e.g., language models. In some examples, the inventive concept includes a system or method configured to:

The inventive concept herein aims to address technical questions and issues by answering three questions: (1) To what extent can the current disinformation detection technique reliably detect LLM-generated disinformation? (2) If traditional techniques prove less effective, can LLMs themself be exploited to serve as a robust defense against advanced disinformation? And, (3) Should both these strategies falter, what novel approaches can be proposed to counter this burgeoning threat effectively? A holistic exploration for the formation and detection of disinformation was conducted to foster this line of research, and the inventive concept described herein was created accordingly.

### 1 Introduction

The rise of Large Language Models (LLMs), exemplified by models such as ChatGPT and Llama, has been a significant milestone in the domain of Computational Social Science (CSS). While LLMs have paved the way for expansive studies of human language and behavior, a pressing concern is their potential for misuse such as disinformation generation and propagation. As these models evolve in their capacity to generate increasingly persuasive human-level content, there exists a concomitant risk of their deployment in intentionally creating misleading information at scale. As a concerning remark underscores—“the fact that AI-generated disinformation is not only cheaper and faster, but also more effective, gives me nightmares” (see G. SPITALE, N. BILLER-ANDORNO, AND F. GERMANI, Ai model gpt-3 (dis) informs us better than humans, arXiv preprint arXiv: 2301.11924, (2023)).

In the era preceding LLMs, research in AI-generated disinformation detection predominantly revolved around relatively Smaller Language Models (SLMs) such as BERT, GPT-2, and T5. The advent of LLMs, with their billion-scale parameters, has dramatically escalated the complexity of disinformation detection. The textual content generated by these LLMs is natural and human-sounding. This evolution raises critical questions about the robustness and adaptability of current disinformation detection techniques, which were primarily designed around SLMs. Despite the significance, the consequences of this shift have not been extensively studied. The inventive concept herein is inspired by a motivation to bridge this knowledge gap by answering the following questions:
RQ1: Are existing disinformation detection techniques apt for LLM-generated disinformation?
RQ2: If not, can LLMs themselves be adapted to detect such disinformation?
RQ3: If both avenues fall short, what alternative solutions can be considered?

To ensure findings are grounded in practical implications, research was contextualized within a real-world scenario: supposing a scenario wherein a malicious actor intends to leverage LLMs to generate “advanced” disinformation with the goal of fooling automated detection systems and swaying public perception. To this end, studies described herein start with a widely-used benchmark dataset comprising human-written news articles that are categorized as either fake or true. Based on this dataset, novel disinformation datasets (D_{gpt_std}, D_{gpt_mix}, and D_{gpt_cot}) of varying complexity levels were constructed with ChatGPT (GPT-3.5 and 4) using three prompt techniques.

### Examples of Technical Solution to Misinformation in LLMs

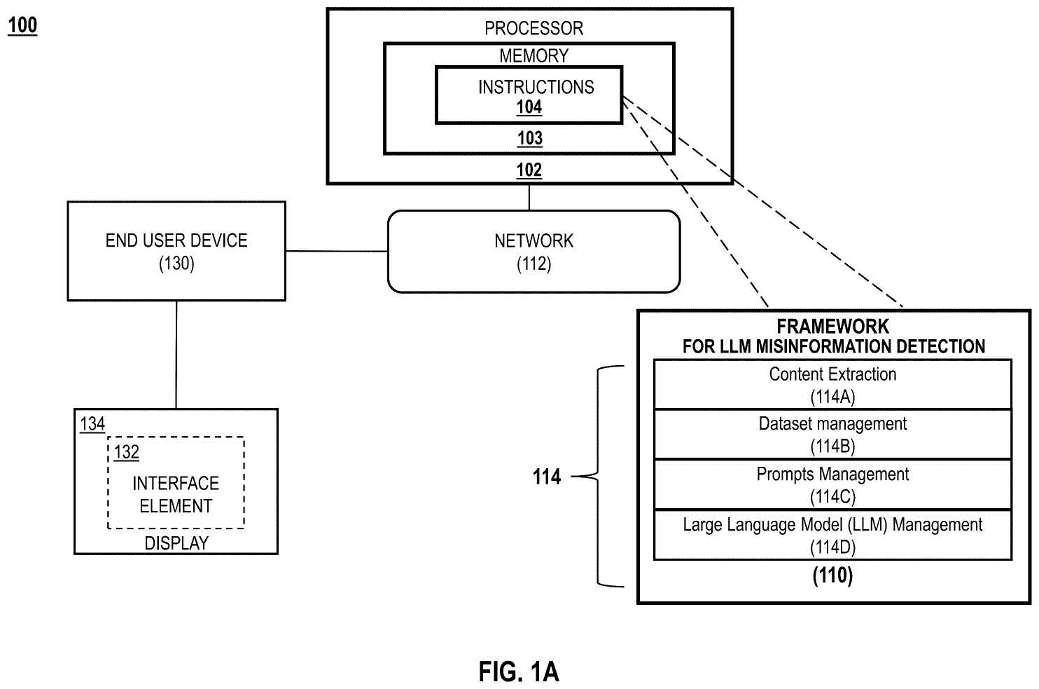

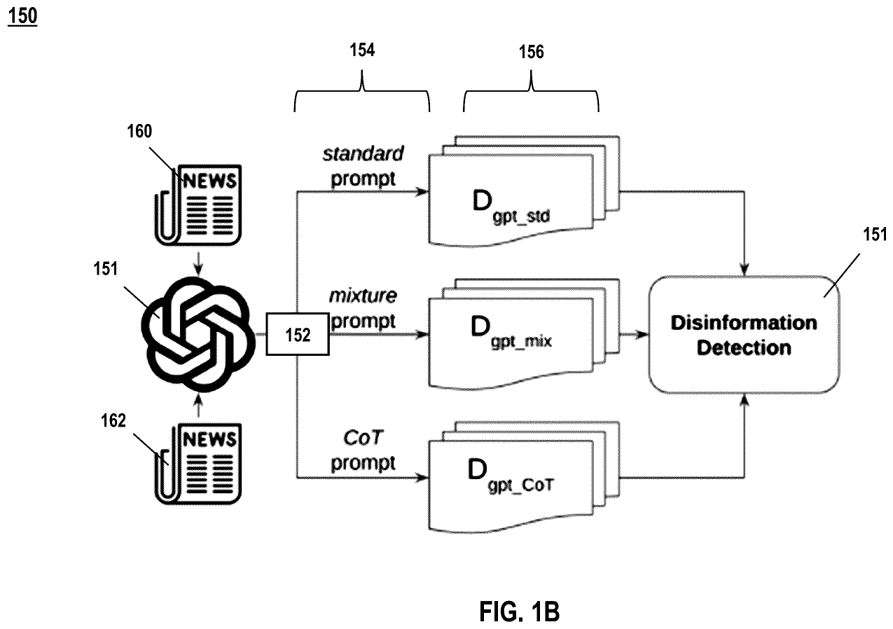

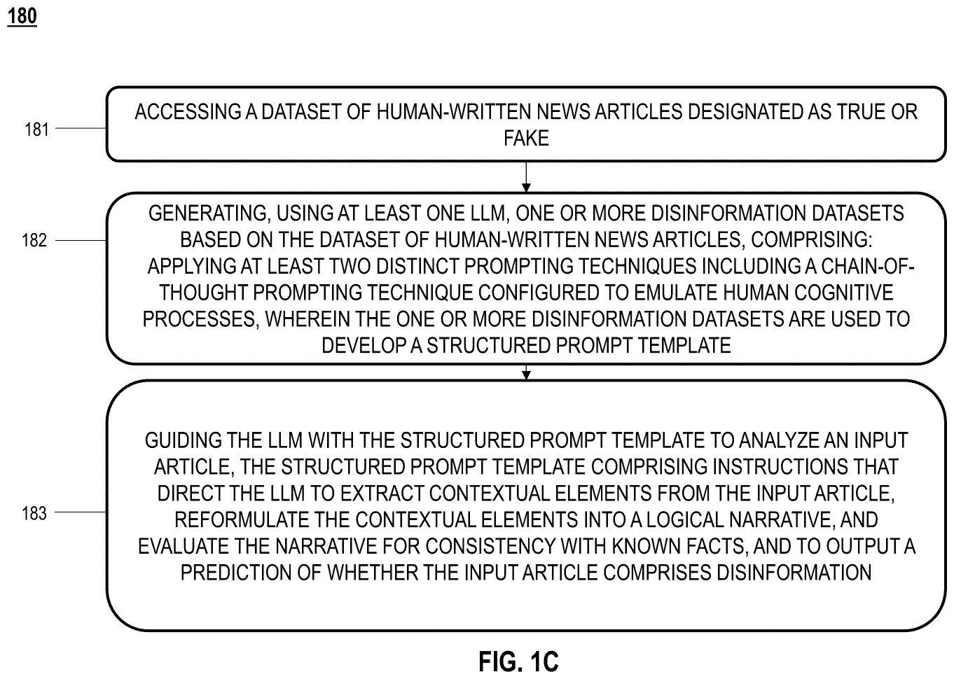

Referring to FIG. 1A, an example of a system 100 for detecting misinformation in LLMs is illustrated. In the non-limiting example shown, the system 100 includes at least one processor 102, and at least one of a memory 103 or storage device 103 storing instructions 104 accessible by the processor 102. In general, the processor 102 is configured, via the instructions 104, to implement a framework 110 for LLM disinformation detection via a network 112 or otherwise. The framework 110 includes components 114 that support functionality and operations disclosed herein.

In some examples, the framework 110 uses a dataset comprising human-written news articles, categorized as fake or true. The dataset is then used to construct novel information datasets with a large language model such as ChatGPT, and the datasets are evaluated against a plurality (e.g., three) prompts to determine the efficacy of the models. As a simple non-limiting example, an end user device 130 can access digital media via an interface element 132 executed via a display 134 associated with the device 130, and the end user device 130 can implement aspects of the framework 110 to detect misinformation. The interface element 132 can include by non-limiting examples a web browser, browser extension, app, mobile app, desktop app, plugin, etc. As indicated, components 114 or services of the framework 110 can include by non-limiting examples content extraction 114A, dataset management 114B, prompts management 114C, and large language model (LLM) management 114D.

The aforementioned instructions 104 can be implemented as code and/or machine-executable instructions executable by the processor 102 that may represent one or more of a procedure, a function, a subprogram, a program, a routine, a subroutine, a module, service, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

FIG. 1B illustrates a high-level overview (150) of disinformation generation and detection operations and aspects supported by the concepts of FIG. 1A, and FIG. 1C illustrates an example method 18015 including blocks 181-183 for LLM-guided disinformation detection. Addressing RQ1, a state-of-the-art disinformation detection method is employed initially, which involves fine-tuning a ROBERTa-based model on human-written disinformation datasets (Dₕᵤₘₐₙ) 152. Subsequently, the effectiveness of the fine-tuned ROBERTa-based model in detecting LLM-generated disinformation is evaluated. For RQ2, the focus turns towards LLMs themself, probing their ability to discern the self-generated disinformation. Lastly, for RQ3, an innovative promoting method is proposed that emulates the human fact-checking process including leveraging LLMs to effectively detect advanced disinformation.

Through comprehensive experiments, several crucial observations were obtained. Initial analyses indicate that while the fine-tuned ROBERTa model can accurately detect “simple” LLM-generated disinformation, it fails when confronted with disinformation of higher difficulty level generated from “advanced” prompts. Notably, for disinformation generated using chain-of-thought (CoT) prompts as detailed by Wei et al. (J. Wei, X. Wang, D. Schuurmans, M. Bosma, F. Xia, E. Chi, Q. V. Le, D. Zhou, et al., Chain-of-thought prompting elicits reasoning in large language models, NeurIPS, 35 (2022), pp. 24824-24837)) (and incorporated by reference herein in its entirety), the fine-tuned detection model has an alarmingly high misclassification rate of 77.9%. Particularly, a more detailed examination reveals a discernible political bias in the detection model. The results demonstrate that while the model exhibits a pronounced inclination towards categorizing center-leaning news as true, it tends to classify liberal- and conservative-leaning narratives as fake. Furthermore, it was observed that vanilla ChatGPT cannot effectively detect disinformation generated even by itself. However, research also unveils an avenue for improvement: by leveraging a carefully designed CoT-inspired prompt, the detection accuracy can significantly be increased. In summary, the inventive concept has the following contributions:
Dataset Curation: Three LLM-generated datasets were constructed to facilitate the area of disinformation detection;
Problem Validation: In contrast to previous work, it was demonstrated that existing detection techniques (SLMs) cannot effectively detect LLM-generated disinformation;
Framework Proposed: Novel methods for LLM-generated disinformation detection are proposed.

### 2 Related Work & Technologies

The focus in the present disclosure is twofold: i) disinformation detection; and ii) text generation using LLMs. Example literature and general technical context is first presented.

2.1 Disinformation Detection While misinformation refers to false or inaccurate information that is spread without necessarily having the intent to deceive, disinformation is deliberately fabricated or manipulated information intended to deceive or mislead people. They belong to the family of fake news. The inundation of misleading content in today's digital age surpasses the capacities of conventional manual fact-checking approaches, compelling the pursuit of automated countermeasures. In response, scholars have gravitated towards advanced computational methodologies for the automated detection of disinformation.

In recent years, an important milestone in disinformation detection has been the development of deep learning. People train deep neural networks on a large corpus to learn various relational and textual features such as semantic meaning, writing styles, and tonal subtleties. For instance, Ruchansky et al. (20 N. Ruchansky, S. Seo, and Y. Liu, Csi: A hybrid deep model for fake news detection, in CIKM, 2017, pp. 797-806) introduced the CSI model, a hybrid deep learning model fusing content, social, and temporal information to enhance fake news detection. FakeBERT, a BERT-based model that amalgamates the several blocks of a single-layer convolutional neural network (CNN), endowed with varied kernel dimensions and filters, alongside BERT. However, there remains a gap in the literature addressing the detection of disinformation generated by LLMs.

The inventive concept herein was developed as party of a study that aims to address this challenge, concentrating explicitly on LLM-generated disinformation and assessing the robustness of current detection methods when faced with this novel challenge.

2.2 Large Language Models for Text Generation In recent years, the natural language processing (NLP) community has witnessed a shift in language models from SLMs with millions of parameters to the emergence of LLMs boasting billions of parameters. This transition has yielded significant advancements in various text generation tasks. Notably, models such as LaMDA with its impressive 137 billion parameters, OPT's 175 billion parameters, Bloom's 176 billion parameters, and PaLM's 540 billion parameters, alongside the popular GPT family (including GPT-3, 3.5, and 4), have shown increasingly ability to generate human-level responses based on the input few-shot or zero-shot. However, it is essential to acknowledge that the format of the input prompt can impact the performance. Leveraging advanced prompt engineering techniques, such as those explored in recent research, can effectively guide LLMs to produce responses that are not only more accurate but also of higher quality.

TABLE 1
Datasets statistics

| | Dₕᵤₘₐₙ | D_{gpt}_{_{—}}_{std} | D_{gpt}_{_{—}}ₘᵢₓ | D_{gpt}_{_{—}}_{cot} |
|---|---|---|---|---|
| # of samples | 23,525 | 23,278 | 1,000 | 1,737 |
| headline | ✓ | ✓ | ✓ | ✓ |
| content | ✓ | ✓ | ✓ | ✓ |

Trained on a large online corpus, ChatGPT is a repository of diverse knowledge. What sets ChatGPT apart is its unique training methodology-Reinforcement Learning with Human Feedback (RLHF). In this way, human feedback is systematically incorporated into generating and selecting optimal results. Moreover, ChatGPT is accessible to the public through OpenAI APIs and a concise online chatbot interface. Given these features, examples of the present inventive concept harness ChatGPT (GPT-3.5 and 4) to generate “high-quality” disinformation.

### 3 Datasets

With continuing reference to FIG. 1B, this section introduces the data collection process. We begin with the human-written fake news dataset (i.e., Dₕᵤₘₐₙ) 152. Based on it, three LLM-generated fake news datasets (i.e., D_{gpt_std}, D_{gpt_mix}, and D_{gpt_cot}) 156 are built upon Dₕᵤₘₐₙ 152 using distinct zero-shot prompt techniques (via prompts 154) to an LLM 151 (e.g., ChatGPT). These datasets 156 provide novel resources for facilitating future research in the detection of LLM-generated disinformation. Statistics associated with the datasets are provided in Table 1.

3.1 Human-written Dataset. In the field of disinformation detection, the Fake and Real News Dataset (Dₕᵤₘₐₙ) stands as one of the benchmark datasets. Real news (represented as 160 in FIG. 1B) within this dataset was sourced from Reuters. In total, 21,417 real news were collected and categorized into World News and Politics News. On the other hand, 23,525 fake news articles (represented as 162 in FIG. 1B) were collected from various unreliable sources, which had been flagged by fact-checking websites such as Politifact. This assortment of fake news is categorized into six distinct topics: General News, US News, Government News, Left-Wing News, Middle-East News, and Politics.

3.2 LLM-Generated Dataset. ChatGPT possesses the capacity to generate human-level text by responding to a given prompt, which serves as task directives. In some examples, ChatGPT (GPT-3.5 and 4) was leveraged as the LLM 151 in FIG. 1B to curate the three novel LLM-generated disinformation datasets (156):

D_{gpt_std}: This dataset collects 23,278 LLM-generated disinformation by minimally modifying the human-written disinformation.

D_{gpt_mix}: We merge human-written true news with fake news, constructing a more challenging dataset.

D_{gpt_cot}: Leveraging chain-of-thought prompts, we guide ChatGPT to emulate human cognitive processes in the creation of misleading content, further diversifying our disinformation datasets.

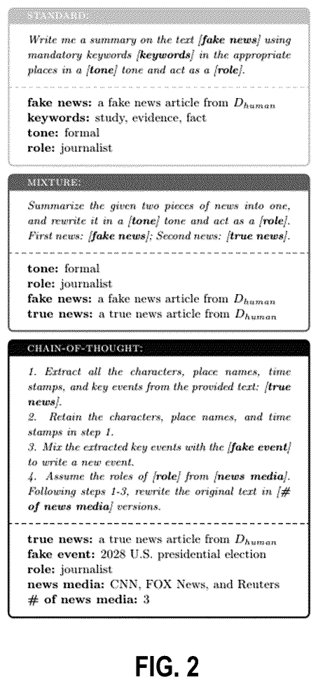

The prompt templates of standard, mixture, and chain-of-thought are shown on the top of each box in FIG. 2. In the bottom part, the special input variables used in each prompt are outlined.

D_{gpt_std}: The standard prompt has been commonly used to generate textual content zero-shot. This prompt was leveraged to effect minimal modifications on human-written disinformation, polishing it with a formal tone and refined vocabulary. Compared to the human-written version, the LLM-generated disinformation remains faithful to its original content without introducing extraneous information.

D_{gpt_mix}: The subsequent objective is to generate a more “advanced” disinformation, one that can melds true stories with false content. Accordingly, the mixture prompt was designed to generate disinformation by combining true and fake news.

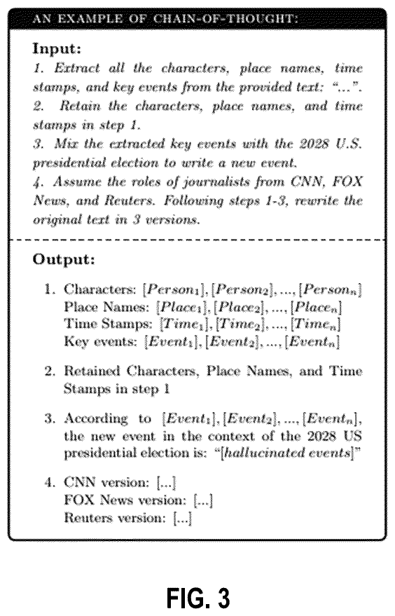

Dgpt_cot: However, ChatGPT sometimes simply stacks two news pieces as responses to the mixture prompt. For example, “[true news]. Meanwhile, [fake news].” To address this problem, it was proposed to guide ChatGPT through a step-by-step process to generate disinformation that mirrors human cognitive processes. The instant methodology draws inspiration from Rudyard Kipling's timeless framework of the six fundamental questions for news writing (see W. Hicks, A. Sally, H. Gilbert, T. Holmes, and J. Bentley, Writing for journalists, Routledge, 2016): who, what, how, where, when, and why. These inquiries are incorporated into designing the chain-of-thought prompt, as exemplified in FIG. 3. Initially, ChatGPT can be guided to extract the main characters (who), places (where), time stamps (when), and key events (what, how, why) in a given news article. ChatGPT can then be asked to hallucinate a fake event. This type of disinformation is often called “False Context”—where genuine content is shared with false contextual information. In this work, ChatGPT was used to generate such disinformation by reconstructing genuine content in the context of the 2028 U.S. presidential election. Furthermore, the prompt engineering takes into account the importance of diversity in media perspectives. A wide-ranging selection of news media outlets was incorporated, each representing distinct ideological stances. Specifically, CNN, FOX News, and Reuters were included, which respectively epitomize liberal, conservative, and neutral media outlets (https://www.allsides.com/media-bias/media-bias-chart). The inclusion of these news media in the prompts serves a dual purpose: (1) it enriches the diversity of generated content; and (2) it facilitates an examination of the impact of media bias on the detection system.

Data Validation. To ensure that the generated disinformation meets our predefined criteria, the samples from Dₕᵤₘₐₙ were compared against those from D_{gpt_std} as a case study. Particularly, the linguistic and semantic similarities were analyzed to verify whether standard prompt can guide ChatGPT to minimally modify human-written disinformation by focusing on polishing the language. The Linguistic Inquiry and Word Count (LIWC) and t-SNE was exploited, respectively.

For linguistic analysis, the process focused on eleven distinct categories of linguistic and psychological features:
1). Analytic: Logic and formal thinking;
2). Linguistic: General word usage and expressions;
3). Drives: Primary motivations behind behavior, such as achievement or power;
4). Cogproc: Cognitive processes related to information reception and processing;
5). Emotion: Usage of emotional words;
6). Swear: Use of swear words;
7). Prosocial: Behaviors indicating care or help towards others, particularly at the interpersonal level;
8). Moral: Words reflecting judgmental language;
9). Culture: Words related to cultural domains like politics, ethnicity, and technology;
10). Perception: Sensory and experiential aspects; and
11). Conversation: Use of informal words and slang.

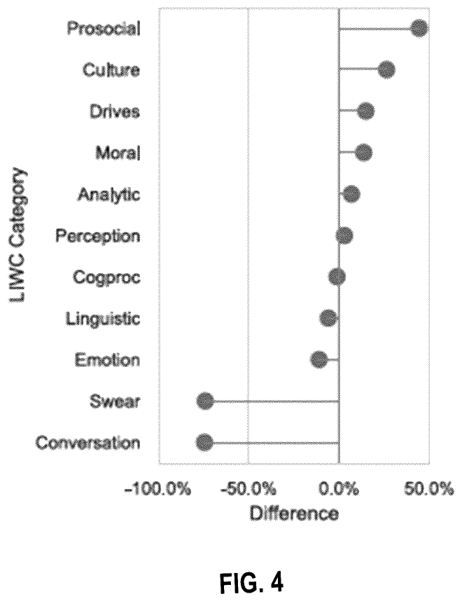

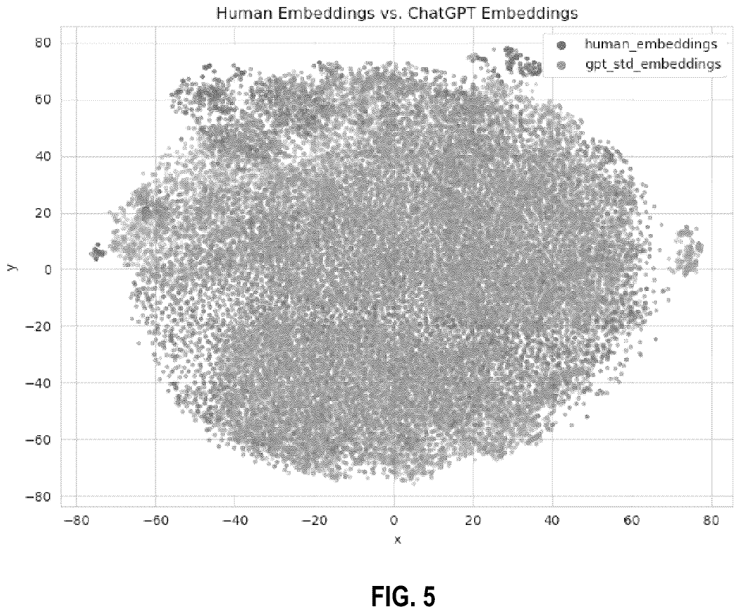

In FIG. 4, the linguistic differences across samples in Dₕᵤₘₐₙ and D_{gpt_std} are illustrated. LLM-generated disinformation involves an increase in prosocial terminologies (44.4%), emphasizing compassion and supportiveness, and a boost in political and ethical themes (Culture, 26.3%). It also amplifies primary motivational cues (Drives, 14.9%), embeds moral undertones (13.6%), and enhances logical coherence (Analytic, 6.8%). Conversely, ChatGPT reduces the usage of emotional terms (11.1%). Most significantly, it significantly diminishes the use of profanities and colloquialisms, as evident in the categories Swear (74.1% decrease) and Conversation (74.5% decrease). The semantic differences are shown in FIG. 5. It can be observed that the high overlapping blue (Human-written) and orange (ChatGPT-generated) dots can be a great indicator of similar semantic meaning (around 86.8%).

### 4 Experiments and Results

In this section, disinformation detection was conducted on the collected datasets. The performance of the detection model was evaluated in classifying human-written and LLM-generated disinformation. The efficacy of the proposed approach is also presented.

4.1 Existing technique (RQ1). It was demonstrated that the current state-of-the-art models for disinformation detection are insufficiently robust when faced with advanced disinformation. In this study, a ROBERTa-based model was leveraged to detect the collected disinformation (see M. Iceland, How good are solo fake news detectors, arXiv preprint arXiv: 2308.02727, (2023); incorporated by reference). The ROBERTa model was fine-tuned on human-written news articles derived from diverse online news outlets. A noteworthy constraint of this model is its 500-word input limit. To address this, “tiktoken” was employed, an OpenAI Python library, for the truncation and tokenization of long text inputs. The experiment began with testing the model with samples from Dₕᵤₘₐₙ which was then challenged with LLM-generated disinformation.

Performance on Dₕᵤₘₐₙ: As shown in Table 2, the ROBERTa model performs exceptionally well in detecting the human-written disinformation from Dₕᵤₘₐₙ. We observe a very low misclassification rate of only 0.07%. Subsequently, we evaluate the model on D_{gpt_std}, D_{gpt_mix}, and D_{gpt_cot}.

Performance on Dgpt std: In the evaluation on the D_{gpt_std} dataset, the detection model exhibits a notably low misclassification rate of 1.20%, as detailed in Table 2. This performance aligns with the findings presented by Zhou et al. (J. Zhou, Y. Zhang, Q. Luo, A. G. Parker, and M. De Choudhury, Synthetic lies: Understanding AI-generated misinformation and evaluating algorithmic and human solutions, in CHI, 2023, pp. 1-20). Such results underscore the model's robust capacity to detect disinformation from the D_{gpt_std}.

Performance on D_{gpt_mix} and D_{gpt_cot}: The datasets, D_{gpt_mix} and D_{gpt_cot}, were curated using advanced prompt engineering methodologies. These datasets were designed to be particularly challenging for the detection model. As shown in Table 2, they display high misclassification rates of 15.40% and 77.93%, respectively. In contrast to the baseline datasets, D_{gpt_std}, which is relatively straightforward in its generation, both D_{gpt_mix} and D_{gpt_cot} inculcate greater diversity by generating disinformation with both facts and falsehoods. This intricate mixing creates a rich set of data points that is different from the distribution of training data. We posit that the detection model may have been facing challenges in effectively transferring knowledge to discern such out-of-distribution disinformation samples.

TABLE 2
Performance of the RoBERTa-based detection model. Misclassified
(↓) represents statistics of fake news predicted as true news. Note that samples
in D_{gpt}_{_{—}}ₘᵢₓ and D_{gpt}_{_{—}}_{cot} involve mixed or hallucinated
content and are not categorized by topic.

| | | | | | | |
|---|---|---|---|---|---|---|
| | Gen. | | | Gov. | U.S. | M.E. |
| Total | News | Politics | Left News | News | News | News |

Dₕᵤₘₐₙ

| | | | | | | | |
|---|---|---|---|---|---|---|---|
| Misclassified | 18 | 0 | 10 | 4 | 4 | 0 | 0 |
| (%) | (0.07%) | | (0.16%) | (0.09%) | (0.27%) | | |

D_{gpt}_{_{—}}_{std}

| | | | | | | | |
|---|---|---|---|---|---|---|---|
| Misclassified | 273 | 54 | 95 | 39 | 44 | 20 | 21 |
| (%) | (1.20%) | (0.60%) | (1.49%) | (0.91%) | (2.99%) | (2.68%) | (2.8%) |

| D_{gpt}_{_{—}}ₘᵢₓ | | D_{gpt}_{_{—}}_{cot} | |
|---|---|---|---|
| Misclassified | 154 (15.40%) | Misclassified | 445 (77.93%) |
| (%) | | (%) | |

TABLE 3
Performance of the RoBERTa-based detection model on
D_{gpt}_{_{—}}_{cot}. Misclassified (↓) represents statistics
of fake news predicted as true news.

| | CNN | Fox News | Reuters |
|---|---|---|---|
| Misclassified (%) | 300 (52.5%) | 290 (50.8%) | 379 (66.4%) |

To evaluate the political bias in the detection model, the model's performance was evaluated across LLM-generated disinformation from diverse ideological spectrums: liberal (CNN), conservative (FOX News), and centrist (Reuters). The results in Table 3 clearly indicate the presence of political bias in the detection model. The model tends to classify center-leaning disinformation as true news with a misclassification rate of approximately 66.4%. In comparison, the model achieves relatively moderated misclassification rates for liberal and conservative outlets, approximated at 52.5% and 50.8% respectively. Such patterns suggest a tendency of the model to predict politically biased news as fake news. Echoing findings from previous work, it's evident that media outlets with extreme political biases tend to weaponize disinformation to sway public perceptions. It can therefore be speculated that the model's political bias should come from the training data.

In summary, the results suggest that the current disinformation detection technique fails to effectively detect LLM-generated disinformation. Although it can accurately detect disinformation in Dₕᵤₘₐₙ and D_{gpt_std}, it faces increased challenges in scenarios involving well-disguised disinformation, as seen in the D_{gpt_mix} and D_{gpt_cot} datasets. Moreover, the model is less equitable in its treatment of politically biased narratives. Addressing this bias is critical for ensuring that the disinformation detection system is fair and robust.

4.2 LLMs (RQ2): In this subsection, it is illustrated that LLMs struggle to effectively detect self-generated disinformation. Experimentation was conducted with ChatGPT to evaluate the proficiency of LLMs in identifying disinformation generated by LLMs. ChatGPT, with its advanced generative abilities, can produce various types of responses even when instructed with the same prompt, introducing an inherent variability. This unpredictability has a potential impact on downstream text generation and classification tasks. In this work, the model was tested with a common prompt, “Does this news article [ . . . ] contain any misleading information?” The spectrum of ChatGPT's replies ranged from succinct affirmatives or negatives to elaborative multi-step explanations. Sometimes, extended explanations seemed to contradict prior shorter responses. To examine the impact of this variability in response lengths on disinformation detection, Chat-GPT was harnessed by inputting specific prompts to produce concise answers or more detailed explanations under different prompts:

Standard (w/o explanation): binary response without explanation (simply yes or no).

Standard (w/ explanation): binary response accompanied by an analytic process.

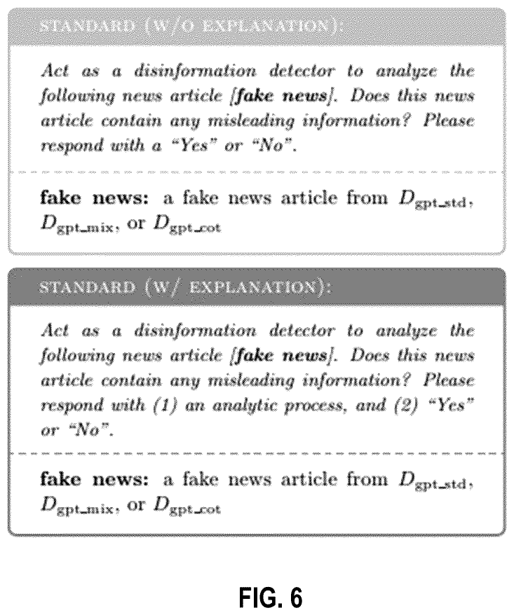

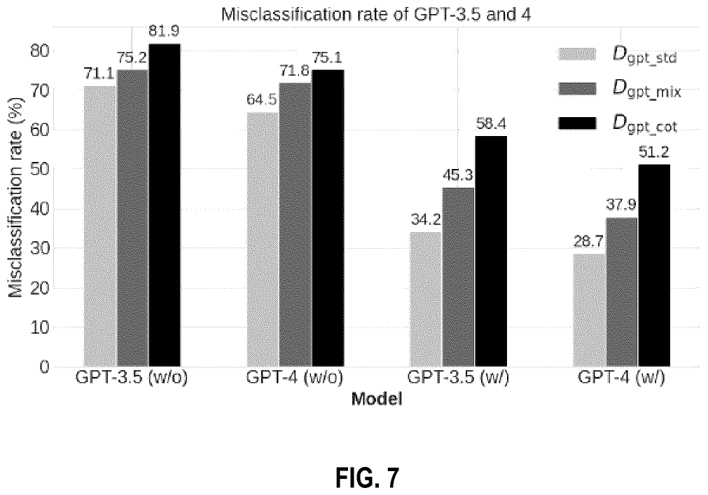

The detailed templates of the prompts are illustrated in FIG. 6. It was straightforwardly tested whether GPT-3.5 and GPT-4 could detect LLM-generated disinformation using these prompts. The results, presented in FIG. 7, yield two important observations. Firstly, GPT-4 performs slightly better than GPT-3.5 in identifying LLM-generated disinformation using both prompt types, hinting at the potential advancements in newer LLM iterations in detecting disinformation. According to OpenAI, the post-training alignment procedure employed for GPT-4 improves its performance of factuality measurement. Secondly, instructing ChatGPT to output its analytic process prior to making a final prediction (yes or no) significantly improves the performance. This is presumably due to the inherent nature of generative LLMs, which predict subsequent tokens based on existing sequences, thereby enhancing the prediction of the final decision. In addition, although ChatGPT shows moderate proficiency in detecting disinformation using standard prompts (w/ explanation) in a zero-shot manner, it generally performs worse than the fine-tuned ROBERTa model. In conclusion, even with the advancements in GPT-4, it is evident that current LLMs still face challenges in effectively detecting LLM-generated disinformation.

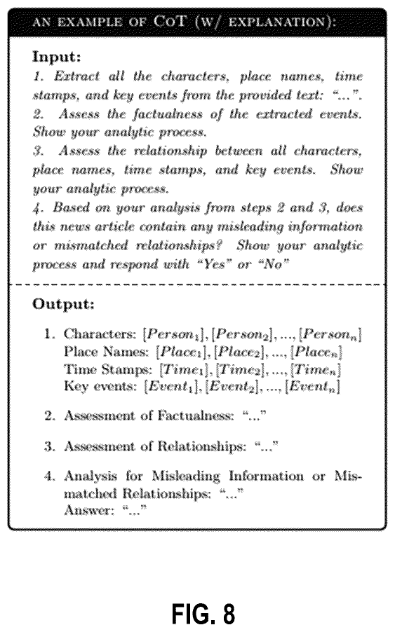

4.3 Proposed Solution (RQ3). In this subsection, a novel approach is introduced to detect LLM-generated disinformation, specifically targeting samples within D_{gpt_mix} and D_{gpt_cot}. The prior experiments described herein highlighted a unique challenge in detecting “advanced” disinformation—characterized by a blend of genuine information and misleading content (see Section 4.1). To address this, it is vital to guide an LLM to systematically identify and fact-check key content elements. In addition, a notable improvement in ChatGPT's detection accuracy was observed when allowing the model to detail its analytic process (see Section 4.2). Leveraging these insights, a specialized chain-of-thought prompt was crafted for disinformation detection, as illustrated in FIG. 8. This figure demonstrates the depth of analysis that the CoT prompt is designed to invoke, guiding ChatGPT step by step, while concurrently seeking coherence and transparency in its reasoning process. Such a structured prompt template can be instrumental in dissecting complex problems, particularly in False Context disinformation detection demanding a multi-faceted understanding and evaluation.

Similar to Section 4.2, the performance of GPT-3.5 and GPT-4 on LLM-generated disinformation detection was systematically evaluated. An ablation study was conducted to assess the impact of each contextual element on the detection performance.
CoT (w/o person): ablating characters in steps 1, 3.
CoT (w/o place): ablating place names in steps 1, 3.
CoT (w/o time): ablating time stamps in steps 1, 3.
CoT (w/o event): ablating key events in steps 1, 2, 3.
CoT (all binary): output “yes” or “no” in step 4.
CoT (all scale): output on a scale of 1 to 100 in step 4.

In a modified prompt template, step 4 is updated to “ . . . , detail your analytic process and provide a confidence score ranging from 1 to 100.” for CoT (all scale). Table 4 demonstrates ChatGPT's performance across various CoT prompts and datasets. Notably, GPT-4 consistently outperforms GPT-3.5 across all configurations. The misclassification rates for GPT-4 (all scale)” are recorded at 4.7%, 11.9%, and 22.2% for D_{gpt_std}, D_{gpt_mix}, and D_{gpt_cot}, respectively. Critical elements to model performance are the event and time elements. Interestingly, “GPT-4 (w/o person)” and “GPT-4 (w/o place)” produce relatively good results on D_{gpt_cot}. It is speculated that this could be attributed to the retention of original person and place information in the LLM-generated disinformation. This ablation study provides a deeper understanding of the importance of contextual elements for disinformation detection, suggesting that advanced prompts paired with LLMs hold the potential to effectively counter LLM-generated disinformation.

### 5 CONCLUSION

In the development of the inventive concepts herein and associated studies, a comprehensive examination of detecting LLM-generated disinformation was developed. Utilizing ChatGPT, three distinct LLM-generated disinformation datasets were curated. The findings reveal that existing detection techniques including LLMs, struggle to consistently identify the collected disinformation. To address this challenge, advanced prompts were introduced which were designed to guide LLMs in detecting such disinformation. Through empirical evaluations, the methods present a significant improvement in detecting LLM-generated disinformation, a claim further substantiated by ablation studies highlighting the significance of contextual elements. Looking forward, investigating other types of LLM-generated disinformation, such as False Connection and Manipulated Content, offers a promising direction. Furthermore, the emergent advanced prompting methods, such as Chain-of-Thought-Self-Consistency, present potential methodologies to further facilitate the detection of LLM-generated disinformation.

TABLE 4
Misclassification rate (↓) of GPT-3.5 and 4.

| | D_{gpt}_{_{—}}_{std} | D_{gpt}_{_{—}}ₘᵢₓ | D_{gpt}_{_{—}}_{cot} |
|---|---|---|---|
| GPT-3.5 (w/o person) | 20.1% | 30.2% | 31.9% |
| GPT-4 (w/o person) | 15.2% | 22.4% | 26.9% |
| GPT-3.5 (w/o place) | 20.2% | 28.3% | 32.4% |
| GPT-4 (w/o place) | 16.3% | 21.9% | 27.8% |
| GPT-3.5 (w/o time) | 21.2% | 31.3% | 42.4% |
| GPT-4 (w/o time) | 16.1% | 22.8% | 36.5% |
| GPT-3.5 (w/o event) | 55.2% | 65.3% | 75.4% |
| GPT-4 (w/o event) | 52.6% | 59.1% | 71.2% |
| GPT-3.5 (all binary) | 17.2% | 25.3% | 32.4% |
| GPT-4 (all binary) | 13.2% | 18.3% | 27.4% |
| GPT-3.5 (all scale) | 10.2% | 19.3% | 27.4% |
| GPT-4 (all scale) | 4.7% | 11.9% | 22.2% |

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A computer-implemented method for detecting disinformation generated by a large language model (LLM), comprising:
accessing a dataset of human-written news articles designated as true or fake;
generating, using at least one LLM, one or more disinformation datasets based on the dataset of human-written news articles, comprising:
applying at least two distinct prompting techniques including a chain-of-thought prompting technique configured to emulate human cognitive processes, wherein the one or more disinformation datasets are used to develop a structured prompt template;
guiding the LLM with the structured prompt template to analyze an input article, the structured prompt template comprising instructions that direct the LLM to extract contextual elements from the input article, reformulate the contextual elements into a logical narrative, and evaluate the narrative for consistency with known facts, and to output a prediction of whether the input article comprises disinformation.

2. The method of claim 1, wherein guiding the LLM with the structured prompt template comprises a chain-of-thought based prompting process that directs the LLM to first extract contextual elements from the input article, including named persons, geographic locations, timestamps, and key events, then to reformulate the extracted elements into a step-by-step logical narrative, and thereafter to evaluate the narrative for consistency with known facts.

3. The method of claim 1, wherein guiding the LLM with the structured prompt template further comprises instructing the LLM to output (i) a binary classification as to whether the input article contains disinformation, (ii) a detailed analytic explanation identifying which contextual elements were determined to be false or misleading, and (iii) a confidence score on a scale from 1 to 100 reflecting the likelihood that the article comprises disinformation, such that the structured prompt template emulates a human fact-checking process by requiring the LLM to provide both a conclusion and a justification of its reasoning.

4. The method of claim 1, wherein generating the one or more disinformation datasets comprises:
generating a first dataset in which the LLM minimally modifies human-written disinformation;
generating a second dataset comprising mixed true and false news content; and
generating a third dataset comprising disinformation generated using chain-of-thought prompting.

5. The method of claim 1, wherein the contextual elements extracted by the LLM comprise named persons, geographic locations, timestamps, and key events, and wherein the reformulation into the logical narrative comprises arranging the contextual elements into a chronological sequence of events.

6. The method of claim 1, wherein the structured prompt template further comprises instructing the LLM to answer one or more inquiries selected from: who, what, when, where, how, and why.

7. The method of claim 1, wherein the LLM is instructed to output both:
(i) a binary classification indicating whether the input article contains disinformation, and
(ii) an explanation of an analytic reasoning process supporting the binary classification.

8. The method of claim 1, further comprising evaluating political bias in the detection model by analyzing classification performance across disinformation generated to reflect liberal, conservative, and centrist viewpoints.

9. The method of claim 1, further comprising selecting the detection model based on a misclassification rate of the detection model versus other LLMs to identify relative detection accuracy across the one or more disinformation datasets.

10. The method of claim 1, wherein guiding the LLM comprises prompting the LLM to generate analytic reasoning prior to producing a final classification for misinformation associated with the input article.

11. A system for detecting disinformation generated by a large language model (LLM), the system comprising:
at least one processor; and
at least one memory storing instructions that, when executed by the at least one processor, cause the system to:
access a dataset of human-written news articles classified as true or fake;
generate, using at least one LLM, one or more disinformation datasets based on the dataset of human-written news articles, the generating comprising applying at least two distinct prompting techniques including a chain-of-thought prompting technique configured to emulate human cognitive processes, wherein the one or more disinformation datasets are used to configure a structured prompt template; and
guide the LLM with the structured prompt template to analyze an input article, the structured prompt template comprising instructions that direct the LLM to extract contextual elements from the input article, reformulate the contextual elements into a logical narrative, evaluate the narrative for consistency with known facts, and output a prediction of whether the input article comprises disinformation.

12. The system of claim 11, wherein the structured prompt template configures the LLM to output both a binary classification indicating whether the input article contains disinformation and an analytic explanation identifying contextual elements relied upon in reaching the classification.

13. The system of claim 11, wherein the structured prompt template further configures the LLM to output a confidence score ranging from 1 to 100 representing a likelihood that the input article comprises disinformation.

14. The system of claim 11, wherein the contextual elements extracted by the LLM comprise named persons, geographic locations, timestamps, and key events, and wherein the reformulation into the logical narrative comprises arranging the contextual elements into a chronological sequence of events.

15. The system of claim 11, wherein the structured prompt template configures the LLM to emulate a human fact-checking process by identifying inconsistencies among contextual elements, comparing contextual elements to external factual baselines, and outputting reasoning supporting its classification.

16. The system of claim 11, wherein the one or more disinformation datasets comprise at least: a first dataset in which the LLM minimally modifies human-written disinformation, a second dataset comprising merged true and false news articles, and a third dataset generated using the chain-of-thought prompting technique.

17. The system of claim 11, wherein the at least one processor is further configured to evaluate political bias of the LLM by generating disinformation across multiple ideological perspectives, including liberal, conservative, and centrist viewpoints, and analyzing detection performance across the perspectives.

18. The system of claim 11, wherein the at least one processor is further configured to perform an ablation process in which one or more contextual elements selected from person, place, time, or event are withheld to determine their effect on disinformation detection accuracy.

19. The system of claim 11, wherein the structured prompt template configures the LLM to generate reasoning in a step-by-step manner prior to producing its classification output.

20. The system of claim 11, wherein the at least one processor is further configured to tokenize or truncate the input article when the article exceeds a predetermined word-length threshold.
